(19) United States
(12) Patent Application Publication
(10) Pub. No.: US 2009/0171779 A1
(43) Pub. Date: Jul. 2, 2009

(54) Mobile Advertisement and Rating System

(75) Inventors: Musiri Shrivathsan, San Jose, CA (US); Nicola A. Crane, San Francisco, CA (US)

Correspondence Address: LAW OFFICES OF MIKIO ISHIMARU, 333 W. EL CAMINO REAL, SUITE 330, SUNNYVALE, CA, 94087, US

(73) Assignee: TELENAV, INC., Sunnyvale, CA (US)

(21) Appl. No.: 11/966,983

(22) Filed: Dec. 28, 2007

(51) Int. Cl. G06Q 30/00

(52) U.S. Cl. 705/14

(57) ABSTRACT

A method of operating a mobile advertisement and rating system includes receiving an advertisement parameter by a client from a server to be shown on a display of the client; detecting an advertisement control parameter with the advertisement parameter in the client; operating the client based on the advertisement control parameter and the advertisement parameter; entering a rating parameter in the client; and sending the rating parameter from the client to the server.

### TECHNICAL FIELD

The present invention relates generally to a location based service system, and more particularly, to a mobile client navigation system having an advertisement and rating system, wherein a mobile client and a server communicate to carry out navigation tasks.

### BACKGROUND ART

Modern portable consumer electronics, especially client devices such as navigation systems, cellular phones, portable digital assistants, and combination devices, are providing increasing levels of functionality to support modern life including location-based information services. Numerous technologies have been developed to utilize this new functionality. Some of the research and development strategies focus on new technologies while others focus on improving the existing and mature technologies. Research and development in the existing technologies may take a myriad of different directions.

As consumers become more empowered with the growth of mobile location based service devices, new and old marketing paradigms begin to take advantage of this new device space. There are many technological solutions to take advantage of this new device location opportunity. One possible approach can be to provide location sensitive advertisement messages that allow advertisement providers to generate more highly targeted and more individually effective advertisements to users. However, the ability for the advertisers to highly target their potential customers on their mobile device having location based services, it does not automatically translate to being an effective marketing or advertisement campaign.

Thus, a need remains for a mobile location based advertisement and rating system to efficiently reach target customers and to efficiently receive feedback to improve the effectiveness of the advertisement campaigns. In view of the ever-increasing added features desired by consumers in their mobile client devices, it is more and more critical that answers be found to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operating a mobile advertisement and rating system including receiving an advertisement parameter by a client from a server to be shown on a display of the client; detecting an advertisement control parameter with the advertisement parameter in the client; operating the client based on the advertisement control parameter and the advertisement parameter; entering a rating parameter in the client; and sending the rating parameter from the client to the server.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 illustrates a mobile advertisement and rating system in an embodiment of the present invention;

FIG. 2 is a block diagram of the mobile advertisement and rating system of FIG. 1;

FIG. 3 is a flow chart of the mobile advertisement and rating system of FIG. 1;

FIG. 4 is a flow chart of the advertisement and route rating system of FIG. 1;

FIG. 5 is a block diagram of the server system of FIG. 1;

FIG. 6A, 6B, and 6C are illustrations of a route selection and rating by the client with the mobile advertisement and rating system;

FIG. 7A, 7B, and 7C are illustrations of an advertisement selection and rating by the client with the mobile advertisement and rating system; and

FIG. 8 is a flow chart of a method for operating the mobile advertisement and rating system in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs. The tern “system” as used herein means and refers to the method and to the apparatus of the present invention in accordance with the context in which the term is used.

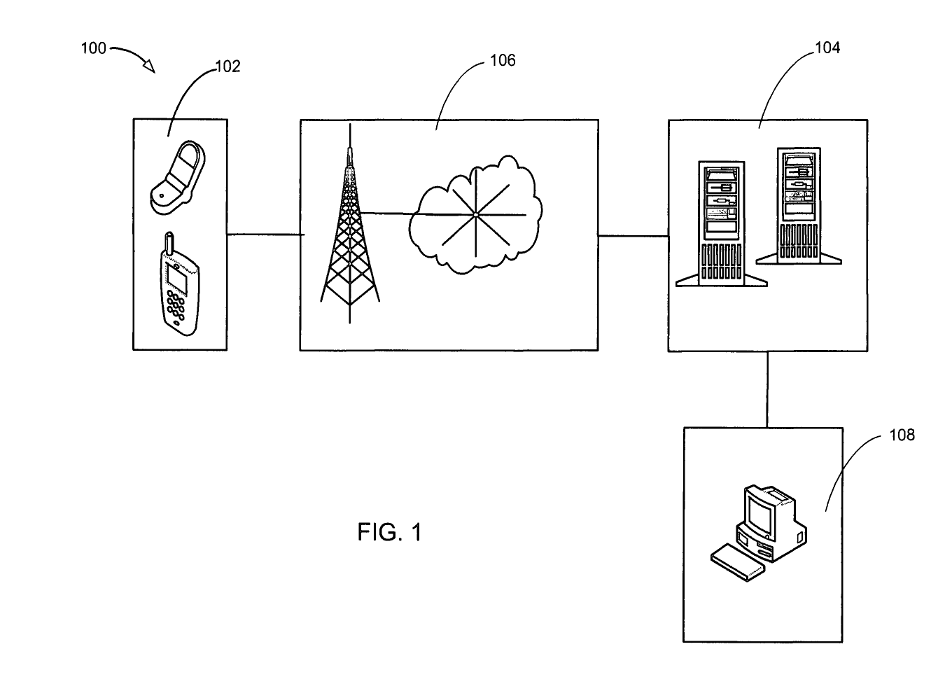

Referring now to FIG. 1, therein is illustrated a mobile advertisement and rating system 100 in an embodiment of the present invention. A client 102 is connected to a communication path 106, such as a wireless telecommunication network, to a server 104. As used herein, the client 102 can be of any of a variety of mobile devices, such as a cellular phone, personal digital assistant, a notebook computer, or other multi-functional mobile communication or entertainment devices having means to couple to a communication path to communicate with a server and means for client location monitoring, preferably, global positioning system (GPS) function.

The client 102 includes, for example, a control device (not shown), such as a microprocessor, software (not shown), a memory (not shown), communication components (not shown), location monitoring components (not shown), and a user interface. The user interface, such as a display, a key pad, touchpad, a microphone, and a speaker, allows the user to interact with the client 102 and to provide advertisement rating inputs. The microprocessor executes the software and provides the intelligence of the client 102 for interaction with the server 104 for relevant information, for the user interface, for interaction with the communication path 106, and interaction to the location monitoring system of the client 102, as well as other functions pertinent to a location based service communication device.

The memory, such as volatile, nonvolatile memory, internal only, externally upgradeable, or a combination thereof, may store the software, setup data, and other data for the operation of the client 102 as a mobile location based service communication device. The memory may also store the relevant information, such as maps, route information, traffic information, advertisement and point of interest (POI), etc., from the server 104 or may be preloaded. The memory may also store the sampled or created relevant information to be transmitted to the server 104.

For example, the functions of the client 102 may be performed by software, firmware, hardware, or a combination thereof. The communication components can include active and passive components, such as microelectronics or an antenna, for interaction to the cellular system of the communication path 106. The navigation components can include the active and passive components, such as microelectronics or an antenna, for interaction with the communication path 106.

The communication path 106 can be of any of a variety of telecommunication networks. For example, the communication path 106 may include wireless communication, wired communication, or the combination thereof. Satellite communication, cellular communication, wireless fidelity (WiFi), and worldwide interoperability for microwave access (WiMAX) are examples of wireless communication that may be included in the communication path 106. Ethernet, digital subscriber line (DSL), fiber to the home (FTTH), and plain old telephone service (POTS) are examples of wired communication that may be included in the communication path 106. Further, the communication path 106 may traverse a number of network topologies and distances. For example, the communication path 106 may include personal area network (PAN), local area network (LAN), metropolitan area network (MAN), and wide area network (WAN).

The server 104 can include a number of devices, for example, a control device (not shown), such as a microprocessor, software (not shown), a memory, communication components (not shown), location monitoring components (not shown), and a user interface. The microprocessor executes the software and provides the intelligence of the server 104 for interaction with the client 102, interaction to the communication system of the communication path 106 and interaction with a server user interface 108.

For illustrative purposes, the server 104 is shown in a single location, although it is understood that the server may be located at different locations. For example, the server 104 may represent servers in a single computer room, and distributed across different rooms or geographical locations. Also for illustrative purposes, the server 104 and the server user interface 108 are shown as separate and discrete components, although it is understood that the server user interface 108 may by included in the server 104. Further for illustrative purposes, the server user interface 108 is shown coupled to the server 104, although it is understood that the server user interface 108 may couple to the server 104 differently. For example, the server user interface 108 may interact with the communication path 106 to communicate with the server 104.

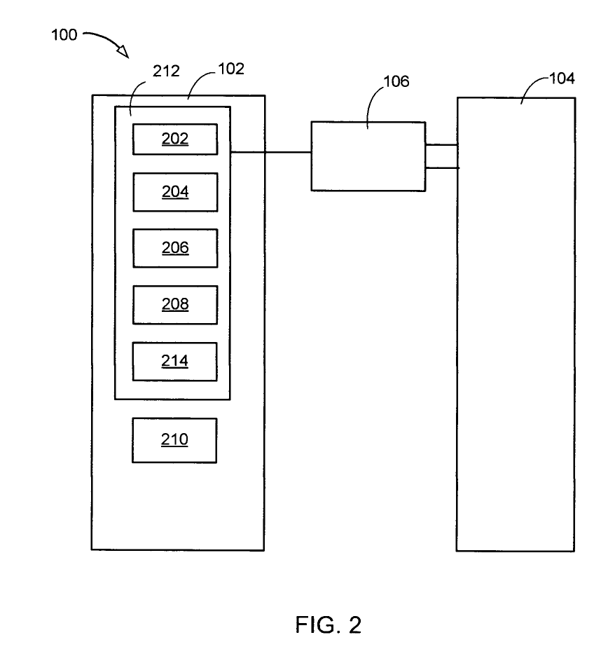

Referring now to FIG. 2, therein is shown a block diagram of the mobile advertisement and rating system 100 of FIG. 1. The client 102 couples with the communication path 106 to send a server request 202 to the server 104. In response to the server request 202, the client 102 receives advertisement parameters 204 from the server 104 over the communication path 106. The client 102 couples with the communication path 106 to send an advertisement rating parameter 206 to the server 104. The client 102 couples with the communication path to send a route rating parameter 208 to the server 104.

For example, the advertisement parameters 204 include control and data parameters for controlling the operation of a display 210 of the client 102, preferably in association with displaying navigation route data received by the client 102. As further described later, the advertisement parameters 204 may include control and data parameters for controlling the operation of the display 210 in association with a variety of navigation events, such as in association with notifying a user of navigational directions, of location-based information or messaging, such as relating to traffic data, point of interests, advertisements, special offers or coupons as an example.

The client 102 may store the advertisement parameters 204 in a local storage 212. The local storage 212 may be implemented in a number of ways. For example, the local storage 212 may be a nonvolatile storage such as non-volatile random access memory (NVRAM) or a volatile storage such as static random access memory (SRAM). The advertisement parameters 204 preferably include locally stored control and data parameters for controlling the operation of the display 210 of the client 102, preferably in association with displaying navigation related to the advertisement parameters 204 received by the client 102 from the server 104 via the communication path 106.

As further described later, the advertisement parameters 204 include an advertisement control parameter 214 For controlling the display 210 of navigation and advertisement events including location specific advertisements, navigational directions, location-based information or messaging, such as coupons or special offers for a local establishment. The advertisement control parameter 214 may preferentially control the operation of the client 102 to automatically generate the advertisement rating parameter 206 and the route rating parameter 208.

The client 102 may accept an input from the user control 32, such as key entry, to provide the advertisement rating parameter 206 for one of the advertisement parameters 204 to send to the server 104 to annotate the advertisement rating parameter 206 for the advertisement parameters 204. The updated information from the advertisement rating parameter 206 will be used by the server 104 to compute or calculate the values for selecting the advertisement parameters 204 that may be subsequently sent back to the client 102.

The client 102 may additionally accept an input from the user control 32 to provide the route rating parameter 208 to send to the server 104 to annotate the navigational information. The updated information from the route rating parameter 208 will be used by the server 104 to compute or calculate the values in navigational information that may be subsequently sent back to the client 102.

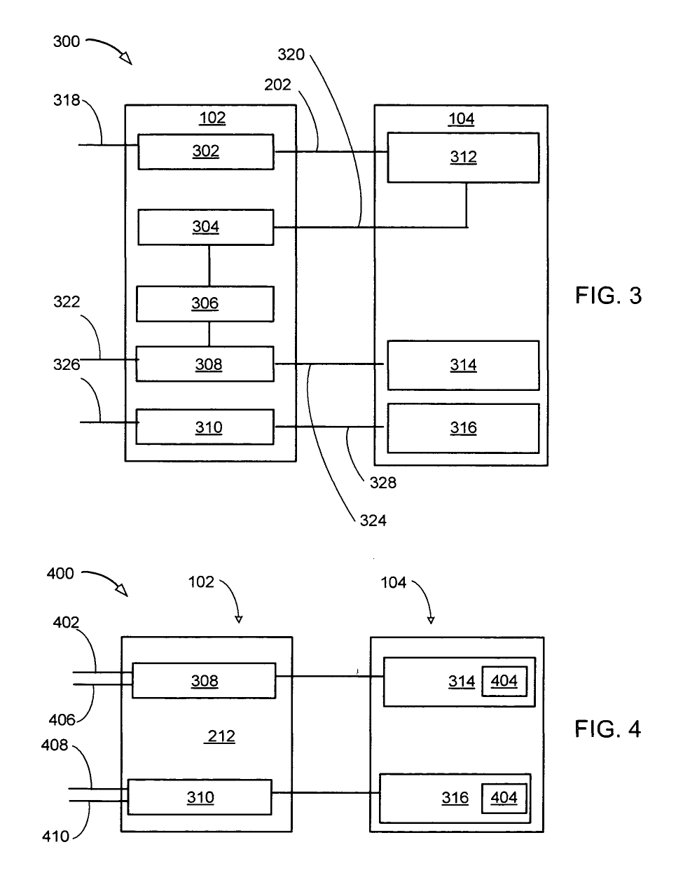

Referring now to FIG. 3, therein shown is a flow chart 300 of the mobile advertisement and rating system 1.00 of FIG 1. In operation, for example, the client 102 preferably receives a destination request 318 from the user input means (not shown) and sends the server request 202 via the communication path 106 of FIG. 1 to the server 104 in a block 302. The server 104 receives the server request 202 from the client 102 and generates the advertisement parameters 204 of FIG. 2 and sends an advertisement response 320 containing the advertisement parameters 204 to the client 102 via the communication path 106 in a block 312. The advertisement parameters 204 may include any number of parameters, such as text, images, audio, video, location parameters, date, time, duration, control actions, display parameters, coupons, special offers, or any combination thereof.

The client 102 receives the advertisement response 320 containing the advertisement parameters 204 from the server 104 over the communication path 106 in a block 304. The client 102 preferably detects the advertisement control parameter 214 for use with the advertisement parameters 204 from the advertisement response 320 and operates the display 210 of FIG. 2 of the client 102 in a block 306.

The client 102 preferably receives an advertisement rating input 322 from the user input means (not shown) and sends an advertisement rating request 324 including the advertisement rating parameter 206 to the server 104 via the communication path 106 in a block 308.

The server 104 receives the advertisement rating request 324 and stores the advertisement rating parameter 206 in the data storage in a block 314. The advertisement rating parameter 206 will be used to modify the selection of the advertisement parameters 204.

For illustrative purposes, the server 104 is described as providing the advertisement parameters 204 to the client 102 as a response to the server request 202 resulting from the destination request 318, although it is understood that the server 104 may provide different responses. For example, the server 104 may provide local service or business information, coupons, and location reminder information in addition to the advertisement parameters 204.

In another example, the client 102 receives a route rating input 326 from the user input means (not shown) and sends a route rating request 328 containing the route rating parameter 208 to the server 104 via the communication path 106 in a block 310. The server 104 receives the route rating request 328 and stores the route rating parameter 208 in the data storage in a block 316. The route rating parameter 208 will be used to modify navigation information.

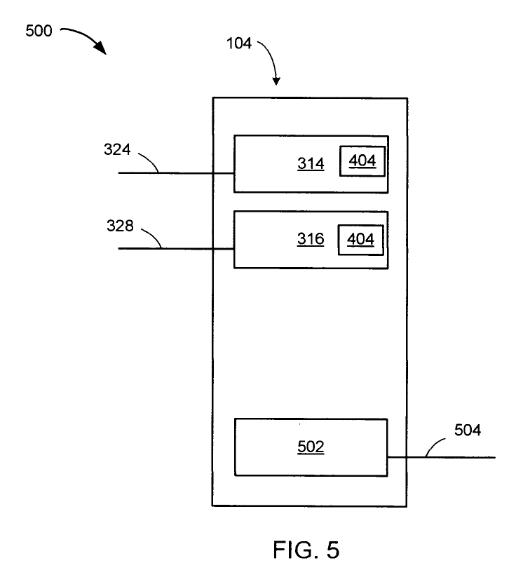

Referring now to FIG. 4, therein shown is a flow chart 400 of the manual and automatic modes of the mobile advertisement and rating system 100 of FIG. 1. In operation, for example, the client 102 can operate in a manual advertisement rating mode determined by the advertisement control parameter 214 of FIG. 2. The client 102 preferably receives a manual advertisement rating input 402 from the user input means (not shown) and sends the advertisement rating parameter 206 of FIG. 2 with the manual advertisement rating input 402 via the communication path 106 of FIG. 1 to the server 104 in the block 314.

The server 104 receives the advertisement rating parameter 206 with the manual advertisement rating input 402 and stores it in a server storage 404, such as disk storage or server main memory, in the block 314. The advertisement rating parameter 206 may include any number of parameters, such as an advertisement selection rating, manual advertisement rating value, time, date, a current location vs. advertisement location rating value, or any manner of advertisement interaction rating parameter including coupon selected, uniform or universal resource locator (URL) selected, supplemental advertisement viewed, navigation route request, or a combination thereof.

The client 102, for example, can operate in an automatic advertisement rating mode determined by the advertisement control parameter 214 and generate an automatic advertisement rating input 406 automatically based on current location and advertisement location for advertisements that are available in the local storage 212 of the client 102. The advertisement rating parameter 206 with the automatic advertisement rating input 406 is sent via the communication path 106 of FIG. 1 to the server 104 in the block 314. The server 104 receives the advertisement rating parameter 206 with the automatic advertisement rating input 406 and stores it in the server storage 404 in the block 314.

The client 102 can operate in a manual route rating mode determined by the advertisement control parameter 214. The client 102 can receive a manual route rating input 408 in the block 310 from the user input means (not shown) and send the route rating parameter 208 of FIG. 2 having the manual route rating input 408 via the communication path 106 of FIG. 1 to the server 104 in the block 316. The manual route rating input 408 may include any number of parameters such as location, speed, direction, traffic conditions, time, date, route identification, or a combination thereof. The server 104 receives the route rating parameter 208 with the manual route rating input 408 and stores it in the server storage 404 in the block 316.

The client 102, for example, can operate in an automatic route rating mode determined by the advertisement control parameter 214 and automatically generate an automatic route rating parameter 410 in the block 310. The automatic route rating parameter 410 can include parameters such as current and expected navigation information for a particular route segment, traffic alerts, time, date, speed, duration or any combination thereof. The route rating parameter 208 having the automatic route rating parameter 410 is sent from the client 102 via the communication path 106 of FIG. 1 to the server 104 in the block 316. The server 104 receives the route rating parameter 208 with the manual route rating input 408 and stores it in the server storage 404 in the block 316.

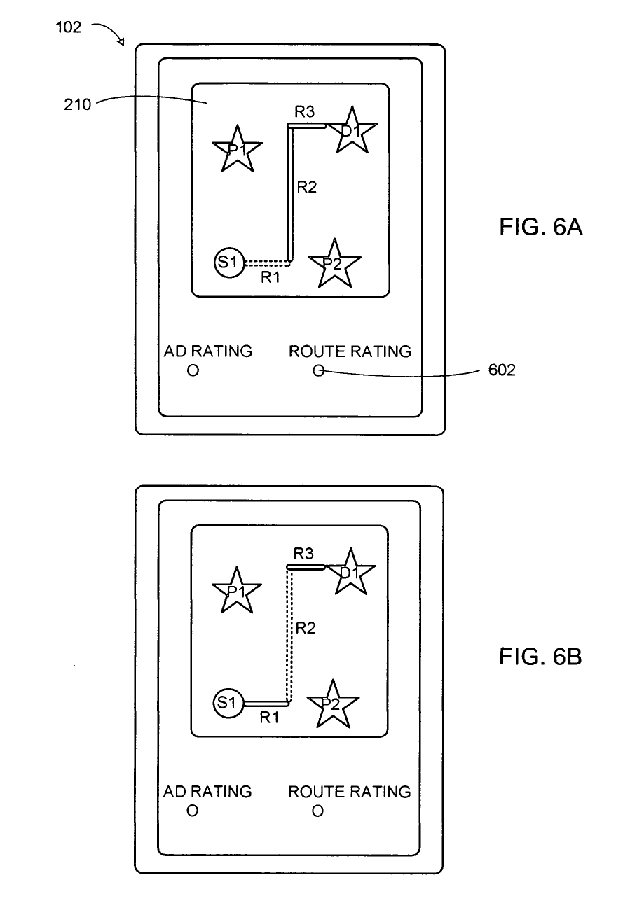

Referring now to FIG. 5, therein shown is a flow chart 500 of the server 104 of the mobile advertisement and rating system 100 of FIG. 1. In operation, for example, the server 104 preferably receives the advertisement rating request 324 from the client 102 of FIG. 1 via the communication path 106 of FIG. 1. The advertisement rating request 324 can include the advertisement rating parameter 206 in the block 314. The server 104 can store the advertisement rating parameter 206 in the server storage 404 that can later be used to update the advertisement parameters 204 based on the advertisement rating parameter 206.

The server 104, for example, can receive the route rating request 328 from the client 102 via the communication path 106. The route rating request 328 can include the route rating parameter 208 in the block 316. The server 104 can store the route rating parameter 208 in the server storage 404 that can be used to modify navigation request responses.

The server 104 in another example can receive a server user input 504, such as from the server user interface 108 of FIG. 1, including the advertisement parameters 204 that may be stored in the server storage 404. The advertisement parameters 204 may include any number of parameters such as text, images, audio, video, location parameters, date, time, duration, control actions, display parameters, coupons, special offers, or any combination thereof. The advertisement parameters 204 in the server storage 404 may be used to generate a set of the advertisement parameters 204 stored in the block 312 of FIG. 3. Selected portions of the advertisement parameters 204 may be based on criteria such as location, route, date, time, user preferences, advertisement rating, advertisement price, special rating values, vendor bidding, rating statistics, threshold values for any of the fore mentioned parameters, or a combination thereof.

The server 104, for example, can provide an advertisement management system 502 that can generate reports showing data such as advertisement status, use, ratings, type of rating or any combination thereof. The server 104 can receive the server user input 504 and provide advertisement management control commands to control and manage the advertisement management system 502.

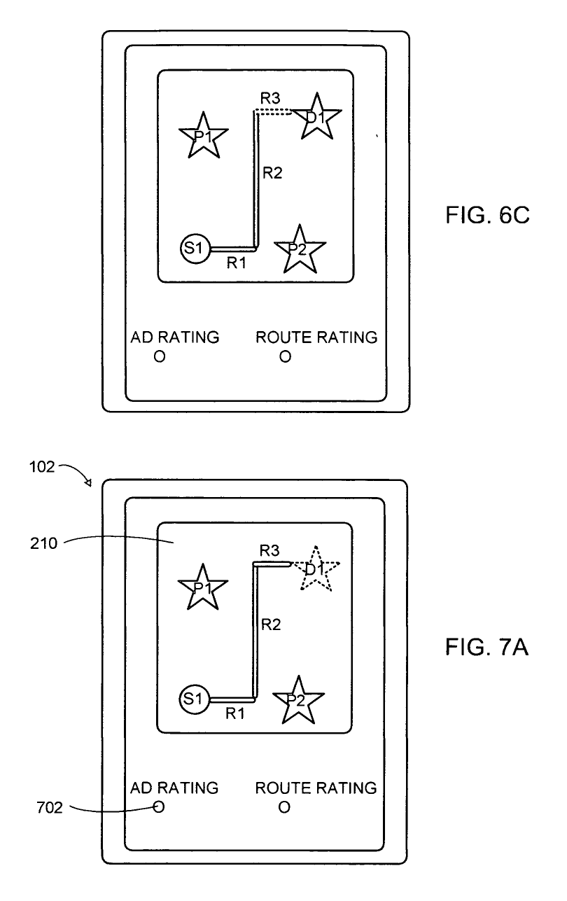

Referring now to FIG. 6, 6A, 6B, and 6C, therein is illustrated a navigation path R1, R2, R3 on the display 210 of the client 102 of the mobile advertisement and rating system 100 of FIG. 1. For example, navigation from the starting point S1 to the destination D1, the client 102 can highlight the current route segment.

In FIG. 6A, the current route segment R1 is highlighted with dotted lines and the focus of any route rating operations. The client 102 can accept the route rating parameter 208 of FIG. 2 for route segment R1 using a route rating control 602 which may include a control input, such as a button, dial, slider, voice input, touch pad, touch screen, virtual button, switch, keypad or similar input device. The client 102 sends the route rating parameter 208 via the communication path 106 of FIG. 1 to the server 104 of FIG. 1. The route rating parameter 208 can incorporate several types of information such as traffic congestion, traffic incident, road quality, detours, road hazards, speed, time, date, weather conditions, road conditions or any combination thereof.

The client 102 in conjunction with the advertisement control parameter 214 of FIG. 2 can preferably enter the route rating parameter 208 automatically. For example in FIG. 6B, at the end of the route segment R2, also depicted with dotted lines, the client 102 can compare the actual duration and compare it to an expected duration value and determine the route rating parameter 208 based on the relative durations and send the route rating parameter 208, which was automatically entered, via the communication path 106 to the server 104.

Also as an example in FIG. 6C, the route R3, depicted by dotted lines, can also be rated in a similar process to R1 and R2. The server 104 can utilize the route rating parameter 208 from the client 102 for R1, R2, R3, or a combination thereof.

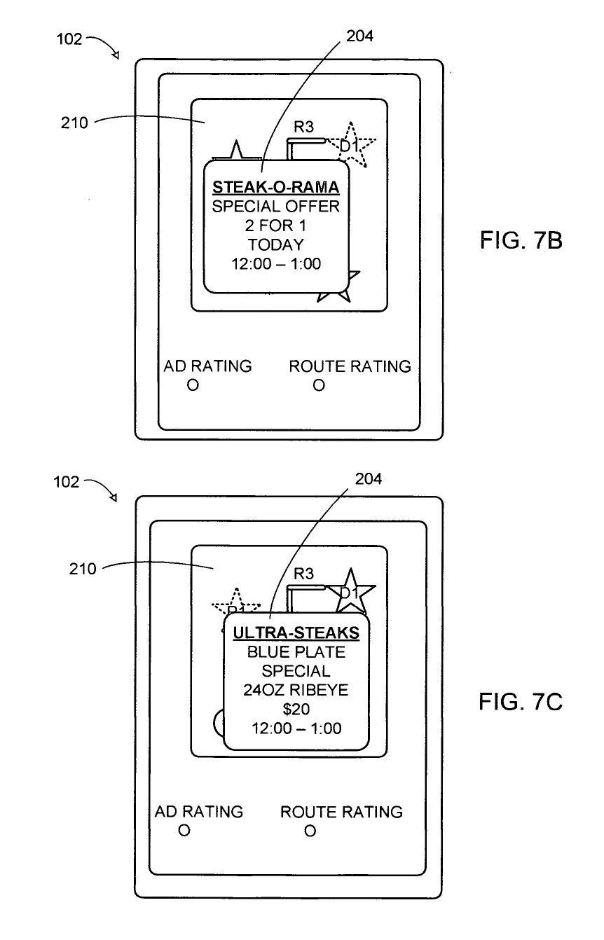

Referring now to FIG. 7, 7A, 7B, and 7C, therein is illustrated a highlighted destination point of interest D1 on the display 210 of the client 102. The client 102 can accept the advertisement rating parameter 206 of FIG. 2 using an advertisement rating control 702 which may include a control input, such as a button, dial slider, voice input, touch pad, touch screen, virtual button, switch, keypad or similar input device. The client 102 sends the advertisement rating parameter 206 via the communication path 106 of FIG. 1 to the server 104 of FIG. 1.

The client 102 can display the destination point of interest D1, depicted as a dotted star, on the display 210 and display the advertisement parameters 204 of FIG. 2 which may be associated with the destination point of interest D1. The advertisement parameters 204 can have a plurality of display formats such as three dimensional billboard, flat ad banner, audio clip, video clip, text message, scrolling message box, popup message, mixed multimedia presentation or any combination thereof.

The client 102 ill conjunction with the advertisement control parameter 21.4 can preferably enter the advertisement rating parameter 206 automatically. For example, the client 102 can detect that the current location and the advertisement location are within a range of distance as indicated by the advertisement control parameter 214 and that the current speed indicates the client 102 had stopped moving. The client 102 sends the advertisement rating parameter 206, which is automatically entered, that indicates that the unit has navigated to the target advertisement location to the server 104 via the communication path 106. It is understood that there are several scenarios where the client 102 can send an automatic advertisement rating parameter to the server 104.

Referring now to FIG. 7B, therein is illustrated a highlighted destination point of interest D1 and the advertisement parameters 204 associated with the point of interest may be shown on the display 210 of the client 102. The client 102 can select a destination point of interest and in conjunction with the advertisement control parameter 214 can present the advertisement parameters 204 associated with the destination point of interest on the display 210.

Referring now to FIG. 7C, therein is illustrated a non-destination point of interest P1, depicted as P1, and the advertisement parameters 204 associated with P1 shown on the display 210 of the client 102 of the mobile advertisement and rating system 100. The client 102 can select an alternate point of interest P1 and in conjunction with the advertisement control parameter 214 can present the advertisement parameters 204 associated with the alternate point of interest P1 on the display 210.

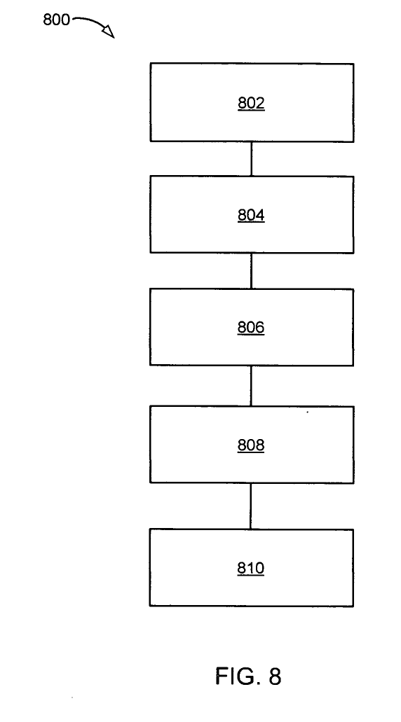

Referring now to FIG. 8, therein is shown a flow chart of a method 800 for operating the mobile advertisement and rating system 100 in an embodiment of the present invention. The method 800 including receiving an advertisement parameter by a client from a server to be shown on a display of the client in a block 802; detecting an advertisement control parameter with the advertisement parameter in the client in a block 804; operating the client based on the advertisement control parameter and the advertisement parameter in a block 806; entering a rating parameter in the client in a block 808; and sending the rating parameter from the client to the server in a block 810.

Yet another important aspect of the present invention is that it valuably supports and services the historical trend of reducing costs, simplifying systems, and increasing performance.

These and other valuable aspects of the present invention consequently further the state of the technology to at least the next level.

Thus, it has been discovered that the mobile advertisement and rating system of the present invention furnishes important and heretofore unknown and unavailable solutions, capabilities, and functional aspects for improving yield, increasing reliability, and reducing cost of mobile client having location based services capability. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A method for operating a mobile advertisement and rating system comprising:
receiving an advertisement parameter by a client from a server to be shown on a display of the client;
detecting an advertisement control parameter with the advertisement parameter in the client;
operating the client based on the advertisement control parameter and the advertisement parameter;
entering a rating parameter in the client; and sending the rating parameter from the client to the server.

2. The method as claimed in claim 1 further comprising modifying the advertisement parameter based on the rating parameter.

3. The method as claimed in claim 1 wherein entering the rating parameter includes entering an advertisement rating parameter.

4. The method as claimed in claim 1 wherein entering the rating parameter includes entering a route rating parameter.

5. The method as claimed in claim 1 wherein entering the rating parameter includes manually entering an advertisement rating parameter.

6. The method as claimed in claim 1 wherein entering the rating parameter includes manually entering a route rating parameter.

7. The method as claimed in claim 1 wherein entering the rating parameter includes automatically entering an advertisement rating parameter.

8. The method as claimed in claim 1 wherein entering the rating parameter includes automatically entering a route rating parameter.

9. The method as claimed in claim 1 wherein receiving the advertisement parameter by the client to be shown on the display includes displaying a three-dimensional rendition of the advertisement parameter on the display.

10. The method as claimed in claim 1 wherein receiving the advertisement parameter by the client to be shown on the display includes displaying a selected portion of the advertisement parameter on the display.

11. A method for operating a mobile advertisement and rating system comprising:
receiving an advertisement parameter by a client, having a navigation and location based services functions, from a server to be shown on a display of the client;
detecting an advertisement control parameter with the advertisement parameter in the client;
operating the client based on the advertisement control parameter and the advertisement parameter;
entering a rating parameter in the client;
sending the rating parameter from the client to the server; and
modifying the advertisement parameter based on the rating parameter.

12. The method as claimed in claim 11 wherein detecting the advertisement control parameter includes controlling the display in a predetermined mode.

13. The method as claimed in claim 11 wherein entering the rating parameter includes entering an advertisement rating parameter for a destination point of interest or an alternate point of interest.

14. The method as claimed in claim 11 wherein entering the rating parameter includes entering a route rating parameter for a route or a route segment.

15. The method as claimed in claim 11 wherein entering the rating parameter includes manually entering an advertisement rating parameter for a destination point of interest or an alternate point of interest.

16. The method as claimed in claim 1.1 wherein entering the rating parameter includes manually entering a route rating parameter for a route or a route segment.

17. The method as claimed in claim 11 wherein entering the rating parameter includes automatically entering an advertisement rating parameter for a destination point of interest or an alternate point of interest.

18. The method as claimed in claim 11 wherein entering the rating parameter includes automatically entering a route rating parameter for a route or a route segment.

19. The method as claimed in claim 11 wherein receiving the advertisement parameter by the client to be shown on the display includes displaying a three-dimensional rendition of the advertisement parameter on the display.

20. The method as claimed in claim 11 wherein receiving the advertisement parameter by the client to be shown on the display includes displaying a coupon on the display.
